(19) United States
(12) Patent Application Publication
(10) Pub. No.: US 2012/0217179 A1
(43) Pub. Date: Aug. 30, 2012

(54) Residential interior tool kit and box

(76) Inventors: Clark Harry, Temecula, CA (US); Tiffany Koepke, Murrieta, CA (US); Mark Erickson, Murrieta, CA (US)

(21) Appl. No.: 12/932,515

(22) Filed: Feb. 28, 2011

(51) Int. Cl. B25H 3/02

(52) U.S. Cl. 206/373

(57) ABSTRACT

A toolkit that is specifically engineered for consumer indoor residential use. This toolkit case is designed to be sturdy but non-marring to sensitive interior finishes with a selection of tools limited to those appropriate for common interior maintenance.

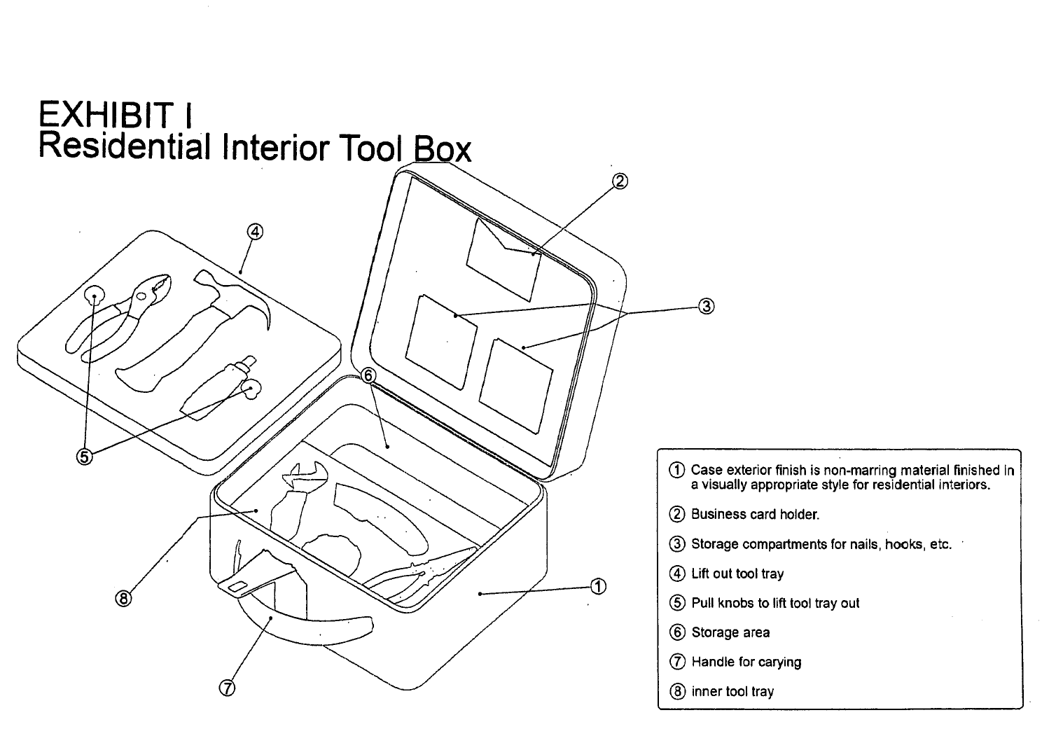

### BACKGROUND AND NEED FOR THE INVENTION

1. Field of the Invention

This invention generally relates to tool boxes and tool kits.

2. Discussion of Prior Art

Tool boxes are typically designed for use in garages or to be portable for use in the outdoors or in commercial or industrial settings. They are typically made of hard material and are most commonly steel, hard plastic or wood. Tool boxes are typically made of very rugged materials in order to withstand the weight and rugged use associated with a garage, commercial or industrial use. The hard surfaces also lend themselves well to easy cleaning when the tools are returned with grease, dirt or other material left on the tools. The metal or hard plastic surfaces are relatively impervious to being stained or damaged and would normally last for many decades.

These typical toolboxes are infrequently used inside a home. The hard surfaces while being very practical would scratch or mar the furniture or flooring in most homes. Steel or hard plastic that is filled with tools can easily be harmful to interior finishes such as: glass table tops, wood flooring or furniture, cloth or leather upholstery. Further, if the tool box had grease or other material smeared on it, that material could be transferred to the furniture or flooring inside the house creating a potentially larger problem for the homeowner than the situation requiring the tool box present to resolve.

There are available various heavy duty vinyl tool boxes that are made for commercial and industrial uses. These are very rugged in design and are made to be in a similar manner to the steel and hard plastic tool boxes.

A substantial percentage of residences are apartments or dwellings with limited or non-existent garage, closet or storage space. Many residences also have detached garages or the parking is provided in a shared parking structure. These circumstances place the occupants of the home in a conflict: they may frequently need the use of a tool box but have no convenient, out of eyesight place to located the tool box. And if the tool box is left within the residence it has the ability to stain, scratch or mar the interior of the home and would normally be considered unsightly.

### SUMMARY OF THE INVENTION

The present invention is designed to be made of a soft material similar to vinyl, patent leather, leather or other suitable material that would make it impossible for the tool kit to harm any household interior finishes. This tool kit would also not incorporate any metal, hard rubber or plastic “feet” or buffers that could scratch or mar household interior surfaces.

The exterior design of the tool box would be generally formulated to be consistent with interior design for residences. The design can be similar looking to a ladies hat box, a purse or travel bag, jewelry box or other common household item.

The tool box would not be designed to be used for commercial or industrial purposes and would be of a size that it would be used for light duty interior residential uses only. The size and number of tools would be limited so that the weight of the tool box would be insufficient to damage the interior finishes.

### DESCRIPTION OF THE INVENTION

A diagram of the invention is included as Exhibit I. The exterior of the tool kit (1) is designed to be made of a soft material similar to vinyl, patent leather, leather or other suitable material that would make it impossible for the tool kit to harm any household interior finishes. The case has a lid that opens and a lower section where the tools are stored. The lid has integrated into it a holder for business cards for trades-people and contractors (2), as well as one or more pockets or storage compartments for nails, picture hooks, etc. (3). Inside the case is a removable tool tray that stores some of the tools on it (4) and the tray has two knobs to lift the tray in and out of the case (5). Inside the case and beneath the removable tray is another level of tools integrated into the bottom of the case (8) with some open area on the bottom of the case for miscellaneous storage (6). The Case has a handle made out of a material that would make it impossible for the tool kit to harm any household interior finishes (7).

1. A case used to store household tools that is made of material sufficiently strong to withstand normal household use but soft enough not to scratch, dent or otherwise mar normal household decor.

2. A household tools kit as claimed in claim 1, wherein on the inside of the lid of the tool kit are pockets for the insertion of business cards for trade contractor contact information.

3. A household tools kit as claimed in claim 1, wherein on the inside of the lid of the tool kit are one or more pockets that opens and closes to hold common small household items such as nails, screws and picture hanging hooks.

4. A household tools kit as claimed in claim 1, wherein the tool kit is designed to compliment the decor of a home, such as a hat box or purse.

5. A household tools kit as claimed in claim 1, wherein the tool kit has special tools that are smaller in scale to be comfortable for woman or people with smaller hands than what is normally found in standard tool kits.

6. A household tools kit as claimed in claim 1, wherein the tool kit has a flat surface on its bottom and also a flat surface when it is standing up on its end so that it can be stored in two different positions, horizontally and vertically.

7. A household tools kit as claimed in claim 1, wherein the tool kit has a removable inner tool tray allowing for two levels of tools. This tool tray would have two knobs for lifting the tool tray in and out of the tool kit.
